(19) United States
(12) Patent Application Publication
(10) Pub. No.: US 2024/0232352 A1
(43) Pub. Date: Jul. 11, 2024

(54) MALWARE DETECTION ON ENCRYPTED DATA

(71) Applicant: Rubrik, Inc., Palo Alto, CA (US)

(72) Inventors: Magesh Kumar Mariappan, Bangalore (IN); Shourya Jaiswal, Bangalore (IN); Kimberly Myles, Bonita Springs, FL (US)

(21) Appl. No.: 18/095,391

(22) Filed: Jan. 10, 2023

(51) Int. Cl. G06F 21/56; G06F 21/60; H04L 9/00

(52) U.S. Cl. CPC G06F 21/566; G06F 21/602; H04L 9/008; G06F 2221/034

(57) ABSTRACT

Methods, systems, and devices for data management are described. A data management system (DMS) may support the detection of malware on encrypted data associated with a computing system that is backed up by the DMS. For example, the DMS may transmit first signaling that instructs the computing system to generate and encrypt one or more machine learning (ML) model features associated with a computing object of the computing system. In response, the DMS may receive second signaling from the computing system that includes the one or more encrypted ML model features. The DMS may use an ML model and the one or more encrypted ML model features as inputs to the ML model to generate and transmit, to the computing system, an encrypted indication of whether malware is present on the computing object.

### FIELD OF TECHNOLOGY

The present disclosure relates generally to data management, including techniques for malware detection on encrypted data.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports malware detection on encrypted data in accordance with aspects of the present disclosure.

FIG. 2 illustrates an example of a computing environment that supports malware detection on encrypted data in accordance with aspects of the present disclosure.

FIG. 3 illustrates an example of a process flow that supports malware detection on encrypted data in accordance with aspects of the present disclosure.

FIG. 4 illustrates a block diagram of an apparatus that supports malware detection on encrypted data in accordance with aspects of the present disclosure.

FIG. 5 illustrates a block diagram of a storage manager that supports malware detection on encrypted data in accordance with aspects of the present disclosure.

FIG. 6 illustrates a diagram of a system including a device that supports malware detection on encrypted data in accordance with aspects of the present disclosure.

FIGS. 7 through 9 illustrate flowcharts showing methods that support malware detection on encrypted data in accordance with aspects of the present disclosure.

### DETAILED DESCRIPTION

A data management system (DMS) may provide backup and recovery services for data of a computing system. For example, the DMS may facilitate the capture (e.g., generation or ingestion) and storage of snapshots of the computing system (e.g., a computing object of the computing system such as a virtual machine, a database, a filesystem, a virtual disk, a virtual desktop, or other type of computing system or storage system), and the snapshots support later recovery (e.g., restoration) of the computing object. Such snapshots may be referred to herein as computing snapshots, or alternatively as snapshots.

The DMS may function as a Software-as-a-Service (Saas) provider and may provide services to a customer (e.g., associated with the computing system), such as a malware detection services for data (e.g., on a computing object of the computing system) backed up by the DMS. In some examples, the DMS may leverage machine learning (ML) models to efficiently detect whether malware is present in the data. For example, the DMS may implement (e.g., and train) an ML model in which the data (e.g., features associated with the data) may be input into the ML model and the ML model may output an indication of whether malware is present or absent from the data.

In some cases, it may be desired to maintain data privacy while performing malware detection. For example, the customer using the malware detection service provided by the DMS may desire to preserve the privacy of the data shared with the DMS. However, in some cases, the data shared with the DMS by the computing system may be plain text data such that the ML model may be able to determine the presence or absence of malware. But plain text data may be raw unencrypted data (e.g., unencrypted features associated with the data). That is, to access (e.g., use) malware detection services provided by the DMS, the computing system may transmit unencrypted data that may be read by any device or system, including the DMS. Accordingly, maintaining data privacy while performing malware detection may be unsupported.

In accordance with examples as described herein, the DMS may implement malware detection techniques that enable both malware detection and data privacy. For example, the DMS may instruct (e.g., cause) the computing system to generate ML model features (e.g., a file size of the computing object, an application programming interface (API) called by the computing object, among others described herein) associated with a computing object of the computing system that may be used by the ML model of the DMS to determine whether malware is present on the computing object. The DMS may also instruct the computing system to encrypt the ML model features, for example, according to a homomorphic encryption scheme. By encrypting the ML model features according to the homomorphic encryption scheme, privacy of the data of the computing object may be maintained while supporting malware detection. For example, homomorphic encryption may support the performance of computations on encrypted data without first decrypting it. That is, homomorphic encryption may be a structure preserving encryption that enables data to be analyzed and used as if still in its original form.

Accordingly, the DMS may receive the encrypted ML model features associated with the computing object and input the encrypted ML model features into the ML model. Using the encrypted ML model features, the ML model may generate and output an indication of whether malware is present on the computing object. Because encrypted ML model features are shared with the DMS, the DMS may be unable to access (e.g., read, determine) the ML model features and data privacy may be maintained. Additionally, because encrypted ML model features are input into the ML model, the indication of whether malware is present is also encrypted, and the DMS is similarly unable to decrypt the indication. The DMS may transmit the encrypted indication to the computing system that may decrypt the indication and determine whether malware is present on or absent from the computing object.

These and additional aspects of the present disclosure are further described below. Aspects of the disclosure are initially described in the context of computing environments. Aspects of the disclosure are additionally described in the context of a process flow. Aspects of the disclosure are further illustrated by and described with reference to apparatus diagrams, system diagrams, and flowcharts that relate to malware detection on encrypted data.

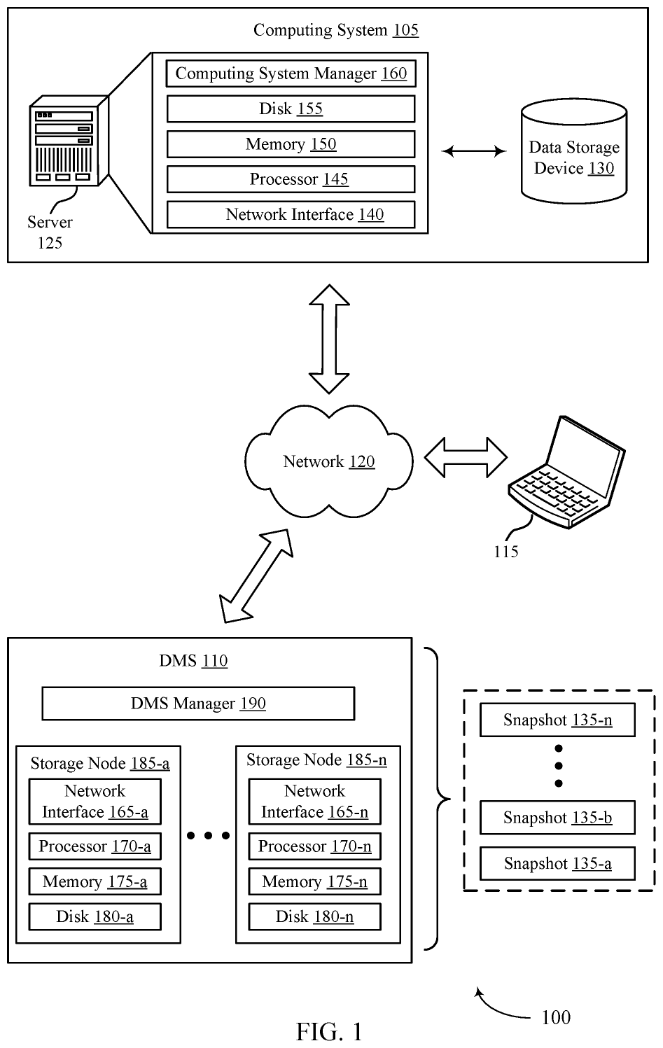

FIG. 1 illustrates an example of a computing environment 100 that supports malware detection on encrypted data in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160) may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing. wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through SaaS or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below:

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state-which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally or alternatively, the DMS 110 may detect whether aspects of the computing system 105 have been impacted by malware (e.g., ransomware). Additionally or alternatively, the DMS 110 may relocate data or create copies of data based on using one or more snapshots 135 to restore the associated computing object within its original location or at a new location (e.g., a new location within a different computing system 105). Additionally or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In accordance with examples described herein, the DMS 110 may provide malware detection services to the computing system 105 while maintaining data privacy of the computing system 105 (e.g., data of computing objects of the computing system 105). For example, the DMS 110 may instruct the computing system 105 to generate and encrypt ML model features associated with a computing object of the computing system 105 for which malware detection procedure is to be performed. The computing system 105 may transmit the encrypted ML model features for malware detection, and the DMS 110 may input the encrypted ML model features into an ML model of the DMS 110. The ML model may be trained to detect the presence of malware using ML model features, and the ML model features associated with the computing object may be encrypted (e.g., according to a homomorphic encryption scheme) such that the ML model may perform the same computations on the encrypted ML model features as if they were unencrypted. Accordingly, the DMS 110 may use the ML model and the encrypted ML model features as inputs to the ML model to generate an encrypted indication of whether malware is present on or absent from the computing object. The DMS 110 may transmit the encrypted indication to the computing system 105, and the computing system 105 may decrypt the indication to determine the result of the malware detection procedure.

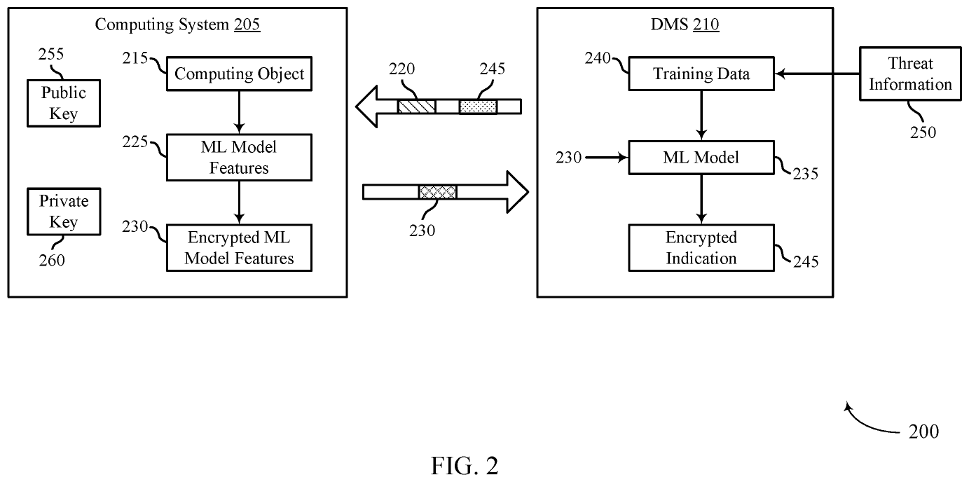

FIG. 2 illustrates an example of a computing environment 200 that supports malware detection on encrypted data in accordance with aspects of the present disclosure. The computing environment 200 may implement or be implemented by aspects of the computing environment 100 described with reference to FIG. 1. For example, the computing environment 200 may include a computing system 205 and a DMS 210, which may be examples of the corresponding systems described herein, including with reference to FIG. 1. The computing environment 200 may support communications between the computing system 205 and the DMS 210. For example, the computing system 205 and the DMS 210 may communicate via a network, such as a network 120 described with reference to FIG. 1.

The computing system 205 may include one or more computing objects 215, which may be examples of a computing object described herein. For example, the computing system 205 may include a computing object 215, such as a virtual machine, a database, a file, a filesystem, a virtual disk, a virtual desktop, among other types of storage systems that may be used to store and manage data of the computing system 205.

The DMS 210 may provide malware detection services for the computing system 205. For example, the DMS 210 may be an example of a SaaS provider that provides various services to the computing system 205, including backup services, recovery services, and malware detection services, among others. For instance, the DMS 210 may manage the extraction, storage, management, and recovery of snapshots (e.g., snapshots 135) of the computing object 215 as described herein. The DMS 210 may also support detecting the presence of malware on the computing object 215.

In some examples, backup and recovery services may be provided without explicit access to data backed up by the DMS 210. For example, in some cases, the DMS 210 may store and recover snapshots of the computing object 215 without direct access to data of the computing object 215. However, in some cases, direct access to the data (e.g., raw, unencrypted data, plain text data) may be needed to support malware detection services. That is, in some cases, the DMS 210 may directly access and analyze the data of the computing object 215 (e.g., plain text data of the computing object may be shared with the DMS 210 by the computing system 205) to determine whether malware is present on the computing object 215. In some cases, however, the computing object 215 may include information (e.g., files, data) that is sensitive or otherwise should remain private (e.g., secure, inaccessible to devices besides the computing system 205, including being inaccessible to the DMS 210). As a result, the plain text data of the computing object 215 may be unable to be shared with the DMS 210, and the DMS 210 may therefore be unable to provide malware detection services for the computing object 215.

To support malware detection while maintaining data privacy, the DMS 210 may facilitate and perform malware detection using information encrypted according to a structure preserving encryption scheme (e.g., a homomorphic encryption scheme). For example, the DMS 210 may transmit signaling (e.g., a control message 220)) to the computing system 205 that instructs the computing system 205 to generate and encrypt one or more ML model features 225 that are associated with the computing object 215. For instance, the control message 220 may instruct (e.g., cause) the computing system 205 to execute (e.g., run) code (e.g., a script provided by the DMS 210 previously or in the control message 220) that generates (e.g., determines, extracts) the one or more ML model features 225 and encrypts the one or more ML model features 225 according to the structure preserving encryption scheme (e.g., the homomorphic encryption scheme). In response to the control message 220, the computing system 205 may generate and encrypt the one or more ML model features 225 (e.g., by executing the code) to generate the one or more encrypted ML model features 230. In some examples, the computing system 205 may encrypt the one or more ML model features 225 using a first key associated with the computing system 205, such as a public key 255 associated with the computing system 205. The computing system 205 may transmit, and the DMS 210 may receive, the one or more encrypted ML model features 230).

The ML model features 225 may be various features that may be used by the DMS 210 to detect the presence of malware on the computing object 215. For example, the DMS 210 may implement an ML model 235 to determine whether malware is present on a given computing object 215. The DMS 210 may use training data 240 to train the ML model 235 to detect the presence or absence of malware on computing objects 215. For example, the DMS 210 may receive threat information 250 (e.g., from a malware database) that the DMS 210 may use as or convert to training data 240. For instance, the threat information 250 may include various ML model features 225 (e.g., associated with computing objects 215 generally) that are known to be indicative of the presence of malware on a computing object 215, various ML model features 225 that are known to be indicative of the absence of malware on a computing object 215, or a combination thereof.

Examples of ML model features 225 that may be generated by the computing system 205 (e.g., and used as part of the training data 240) may include an identifier associated with an API called by the computing object 215 (e.g., executed by the computing object 215), a file size of the computing object 215, one or more changes to the file size of the computing object 215, a file header of the computing object 215, a time of creation of the computing object 215 (e.g., a year of creation, a day of creation, and the like), an entropy associated with the computing object 215 (e.g., a measure of a randomness of data in the computing object 215), packer information associated with the computing object 215 (e.g., software used to compress or encrypt data of the computing object 215), one or more parameters associated with an operating system of the computing system 205 (e.g., an ImageBase of Windows executable, a SectionAlignment of the Windows executable, a FileAlignment of the Windows executable, a SizeOfImage of the Windows executable, a SizeOfHeaders of the Windows executable) or any combination thereof, among other features that may be used in association with detecting malware on the computing object 215.

The ML model features included in the training data 240 may be unencrypted ML model features. That is, the DMS 210 may train the ML model 235 to detect the presence of malware using unencrypted ML model features. Unencrypted ML model features may be used to train the ML model 235 while supporting malware detection using the one or more encrypted ML model features 230 due to the structure preserving nature of the encryption of the ML model features 225. For example, by encrypting the one or more ML model features according to a homomorphic encryption scheme, the one or more encrypted ML model features 230 may be operated on by the ML model 235 as if they were unencrypted (e.g., as if inputting the one or more unencrypted ML model features 225 into the ML model 235). Thus the ML model 235 trained using unencrypted ML model features may use homomorphically encrypted ML model features (e.g., ML model features 230) to determine whether malware is present on the computing object 215. For example, the DMS 210 may generate an encrypted indication 245 of whether malware is present on the computing object 215 by using the ML model 235 and the one or more encrypted ML model features 230 as inputs to the ML model 235.

The DMS 210 may transmit the encrypted indication 245 to the computing system 205. The computing system 205 may decrypt the encrypted indication 245 using a second key associated with the computing system 205, such as a private key 260. For example, the public key 255 may be used to encrypt information, while the private key 260 may be used to decrypt information encrypted using to the public key 255. As such, systems or devices without access to or knowledge of the private key 260 may be unable to decrypt the encrypted indication 245. Accordingly, a privacy of both the data of the computing object 215 and the presence or absence of malware on the computing object 215 may be secured (e.g., known to systems having access to the private key 260, such as the computing system 205, and unknown to system without access to the private key 260, such as the DMS 210).

The encrypted indication 245 may be encrypted based on using encrypted ML model features 230 as inputs to the ML model 235. For example, if encrypted ML model features are input into the ML model 235, the ML model 235 output may be encrypted such that, when decrypted, the output is identical to an output produced using unencrypted ML model features (e.g., unencrypted ML model features 225). That is, the encryption may be maintained as the one or more encrypted ML model features 230 are operated on by the ML model 235 such that the indication of whether malware is present or absent on the computing object is similarly encrypted as to the encryption of the one or more ML model features 225 (e.g., homomorphically encrypted using the public key 255). As such, the presence or absence of malware on the computing object 215 may be unknown the DMS 210. That is, the DMS 210 may be unable to decrypt the encrypted indication 245, for example, due to the lack of access to the private key 260.

By implementing these malware detection techniques, the DMS 210 may support increased data privacy and security while supporting malware detection. For example, because the DMS 210 may be able to use encrypted ML model features 230 to detect the presence of malware on the computing object 215 and generate the encrypted indication 245, the DMS 210 may refrain from (e.g., directly) accessing data of the computing object 215 (e.g., plain text data, unencrypted data) in association with (e.g., as part of) determining whether malware is present on the computing object 215.

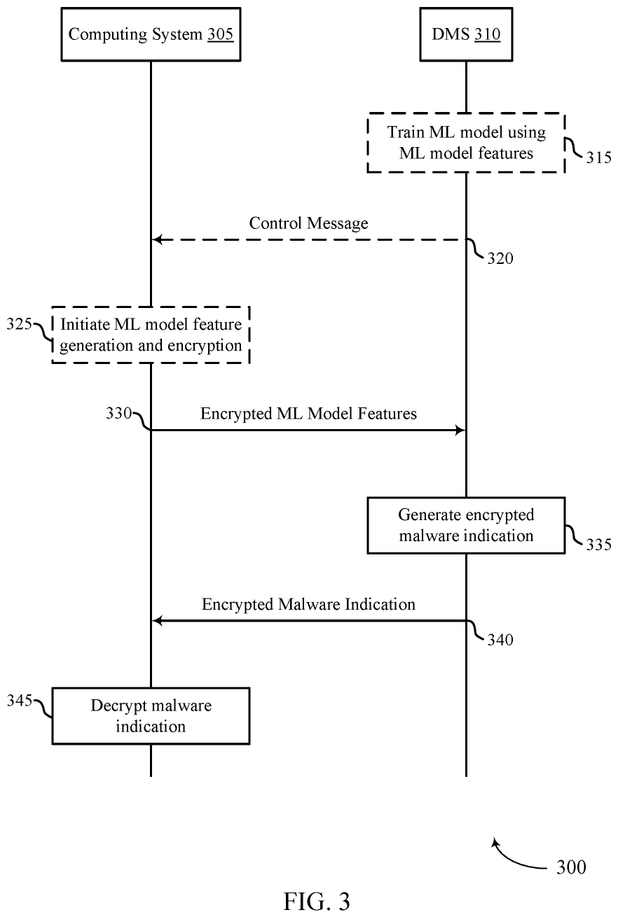

FIG. 3 illustrates an example of a process flow 300 that supports malware detection on encrypted data in accordance with aspects of the present disclosure. The process flow: 300 may implement or be implemented by aspects of the computing environments described with reference to FIGS. 1 and 2. For example, the process flow 300 may be implemented by a computing system 305 and a DMS 310 to support using ML models to detect malware on encrypted data such that data privacy may be maintained and security may be improved, among other benefits.

The computing system 305 and the DMS 310 may be examples of the corresponding systems described with reference to FIGS. 1 through 2. In the following description of the process flow 300, the operations between the computing system 305 and the DMS 310 may be communicated in a different order than the example order shown, or the operations performed by the computing system 305 and the DMS 310 may be performed in different orders or at different times. Some operations may also be omitted from the process flow: 300, and other operations may be added to the process flow 300. Further, although some operations or signaling may be shown to occur at different times for discussion purposes, these operations may actually occur at the same time.

At 315, the DMS 310 may train an ML model at (e.g., implemented by) the DMS 310 using ML model features to determine whether malware is present on or absent from a given computing object. In some examples, the ML model features used to train the ML model may be unencrypted, encrypted (e.g., according to a structure preserving encryption scheme, such as a homomorphic encryption scheme), or any combination thereof.

At 320, the DMS 310 may transmit a control message to the computing system 305. The control message may instruct (e.g., cause) the computing system 305 to generate and encrypt one or more ML model features associated with a computing object of the computing system 305. For example, the DMS 310 may identify (e.g., in response to a request by the computing system 305) the computing object for which the DMS 310 is to perform a malware detection procedure and may transmit the control message to instruct the computing system 305 to generate and encrypt the one or more ML model features. In some examples, the control message may cause the computing system 305 to execute code (e.g., a script, a function) included in the control message or previously provided by the DMS 310 that extracts (e.g., generates) the one or more ML model features based on the computing object. In some examples, execution of the code may also include the encryption of the one or more ML model features. In some other examples, the computing system 305 may encrypt the one or more ML model features extracted by the code after execution of the code.

At 325, the computing system 305 may initiate generation and encryption of the one or more ML model features. In some examples, the computing system 305 may initiate the generation and encryption of the one or more ML model in response to the control message. In some examples, the computing system 305 may initiate the generation and encryption of the one or more ML model without prompt from the DMS 310 (e.g., without receiving the control message). That is, in some cases, the computing system 305 may identify the computing object for which the computing system 305 desires the DMS 310 to perform malware detection and generate and encrypt the one or more ML model features (e.g., without first being instructed by the DMS 310 to do so).

At 330, the computing system 305 may transmit the one or more encrypted ML model features to the DMS 310. In some examples, the computing system 305 may also transmit a request for the DMS 310 to perform malware detection on the one or more encrypted ML model features. In some examples, transmission of the one or more encrypted ML model features may be an implicit request for the DMS 310 to perform malware detection on the one or more encrypted ML model features.

At 335, the DMS 310 may generate an encrypted malware indication of whether malware is present on the computing object. For example, the DMS 310 may input the one or more encrypted ML model features into the trained ML model, and the ML model may output the encrypted malware indication based on the one or more encrypted ML model features. In some examples, the encrypted malware indication may be encrypted due to inputting encrypted ML model features into the ML model.

At 340, the DMS 310 may transmit the encrypted malware indication to the computing system 305. For example, the DMS 310 may be unable to decrypt the encrypted malware indication (e.g., and may not otherwise attempt to decrypt the encrypted malware indication) and may transmit the encrypted malware indication to the computing system 305 after it is output by the ML model.

At 345, the computing system 305 may decrypt the encrypted malware indication to determine whether malware is present on or absent from the computing object. For example, the computing system 305 may encrypt the one or more ML model features using a public key associated with the computing system 305. Such encryption may be maintained as the ML model features are used to generate the encrypted malware indication, and as such, the encrypted malware indication may be decrypted using a private key associated with the computing system 305 and associated with decrypting information encrypted using the public key. In this way, data privacy may be maintained while malware detection is performed for the data. Additionally, the presence or absence of malware on the computing object may be known to the computing system 305 and unknown to the DMS 310 (and other entities without access to the private key).

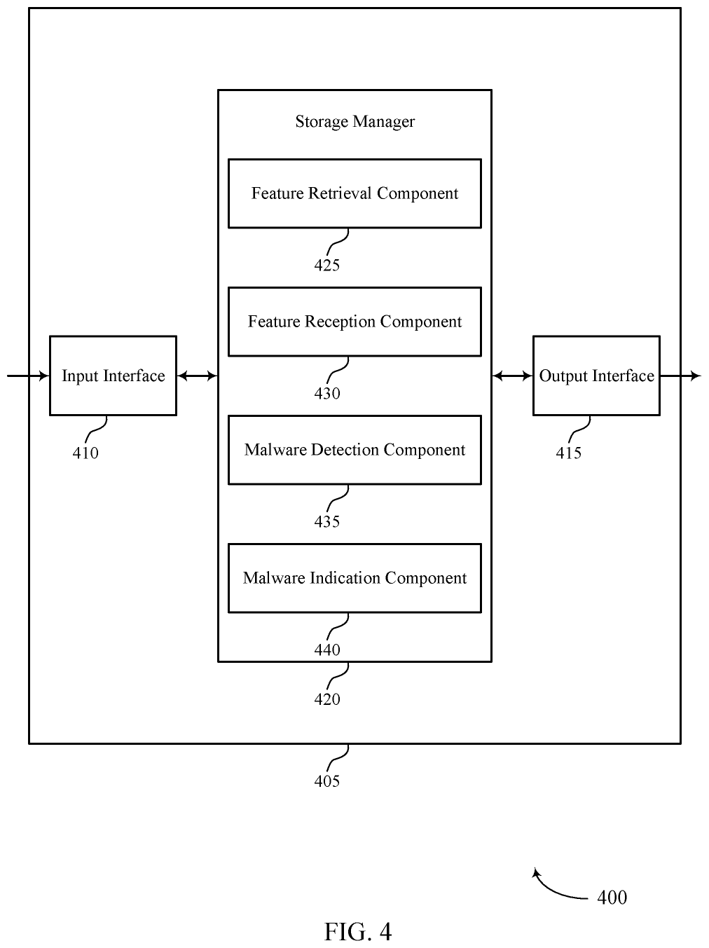

FIG. 4 illustrates a block diagram 400 of a system 405 that supports malware detection on encrypted data in accordance with aspects of the present disclosure. In some examples, the system 405 may be an example of aspects of one or more components described with reference to FIG. 1, such as a DMS 110. The system 405 may include an input interface 410, an output interface 415, and a storage manager 420. The system 405 may also include one or more processors. Each of these components may be in communication with one another (e.g., via one or more buses, communications links, communications interfaces, or any combination thereof).

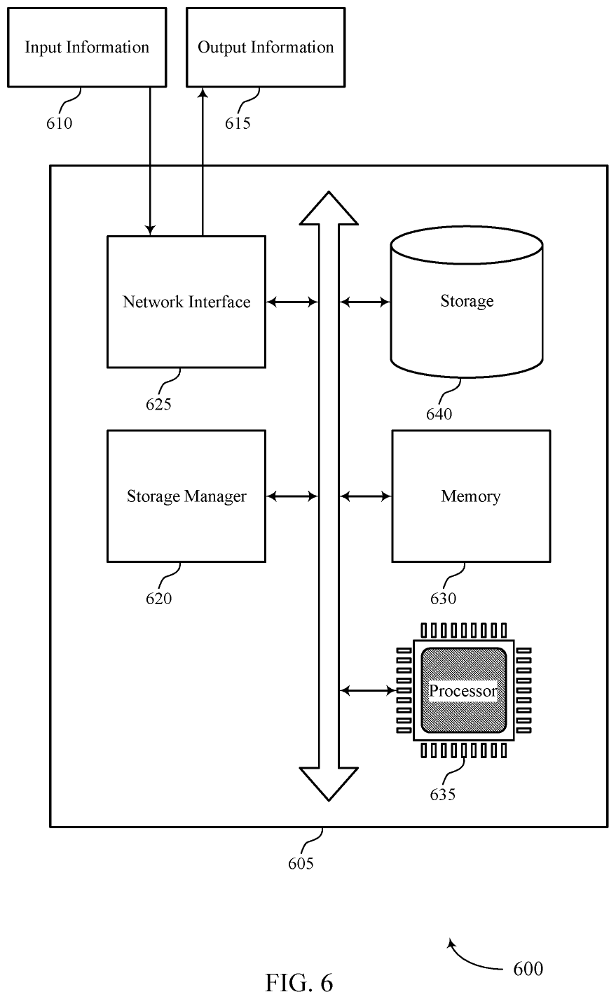

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the storage manager 420 to support malware detection on encrypted data. In some cases, the input interface 410 may be a component of a network interface 625 as described with reference to FIG. 6.

The output interface 415 may manage output signaling for the system 405. For example, the output interface 415 may receive signaling from other components of the system 405, such as the storage manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the storage manager 420 may include a feature retrieval component 425, a feature reception component 430, a malware detection component 435, a malware indication component 440, or any combination thereof. In some examples, the storage manager 420, or various components thereof, may be configured to perform various operations (e.g., receiving, monitoring, transmitting) using or otherwise in cooperation with the input interface 410, the output interface 415, or both. For example, the storage manager 420 may receive information from the input interface 410, send information to the output interface 415, or be integrated in combination with the input interface 410, the output interface 415, or both to receive information, transmit information, or perform various other operations as described herein.

The storage manager 420 may support data management in accordance with examples as disclosed herein. The feature retrieval component 425 may be configured as or otherwise support a means for transmitting, by a DMS (e.g., the system 405) to a computing system backed up by the DMS, first signaling that instructs the computing system to generate and encrypt one or more ML model features associated with a computing object of the computing system. The feature reception component 430 may be configured as or otherwise support a means for receiving, at the DMS from the computing system, second signaling including the one or more encrypted ML model features. The malware detection component 435 may be configured as or otherwise support a means for generating, using an ML model and the one or more encrypted ML model features as inputs to the ML model, an encrypted indication of whether malware is present on the computing object. The malware indication component 440 may be configured as or otherwise support a means for transmitting, from the DMS to the computing system, the encrypted indication.

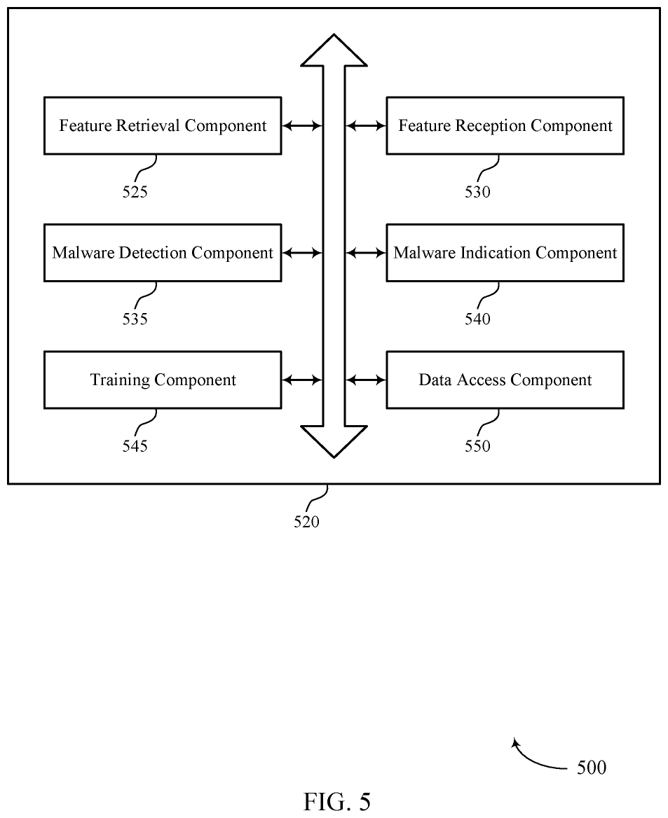

FIG. 5 illustrates a block diagram 500 of a storage manager 520 that supports malware detection on encrypted data in accordance with aspects of the present disclosure. The storage manager 520 may be an example of aspects of a storage manager or a storage manager 420, or both, as described herein. The storage manager 520, or various components thereof, may be an example of means for performing various aspects of malware detection on encrypted data as described herein. For example, the storage manager 520 may include a feature retrieval component 525, a feature reception component 530, a malware detection component 535, a malware indication component 540, a training component 545, a data access component 550, or any combination thereof. Each of these components may communicate, directly or indirectly, with one another (e.g., via one or more buses, communications links, communications interfaces, or any combination thereof).

The storage manager 520) may support data management in accordance with examples as disclosed herein. The feature retrieval component 525 may be configured as or otherwise support a means for transmitting, by a DMS to a computing system backed up by the DMS, first signaling that instructs the computing system to generate and encrypt one or more ML model features associated with a computing object of the computing system. The feature reception component 530 may be configured as or otherwise support a means for receiving, at the DMS from the computing system, second signaling including the one or more encrypted ML model features. The malware detection component 535 may be configured as or otherwise support a means for generating, using an ML model and the one or more encrypted ML model features as inputs to the ML model, an encrypted indication of whether malware is present on the computing object. The malware indication component 540 may be configured as or otherwise support a means for transmitting, from the DMS to the computing system, the encrypted indication.

In some examples, the feature reception component 530 may be configured as or otherwise support a means for receiving, at the DMS, unencrypted ML model features. In some examples, the training component 545 may be configured as or otherwise support a means for using the unencrypted ML model features to train the ML model to detect the presence of malware on the computing object, where generating the encrypted indication is based on training the ML model using the unencrypted ML model features.

In some examples, the one or more ML model features are encrypted according to a homomorphic encryption scheme. In some examples, the ML model trained using unencrypted ML model features is used to detect whether malware is present on the computing object using the one or more encrypted ML model features as inputs based on the one or more ML model features being encrypted according to the homomorphic encryption scheme.

In some examples, the data access component 550 may be configured as or otherwise support a means for refraining, at the DMS, from accessing data of the computing object in association with determining whether malware is present on the computing object based on generating the encrypted indication using the one or more encrypted ML model features.

In some examples, presence or absence of malware on the computing object is unknown to the DMS based on using the one or more encrypted ML model features to generate the encrypted indication.

In some examples, the one or more ML model features include an identifier associated with an API called by the computing object, a file size of the computing object, one or more changes to the file size of the computing object, a file header of the computing object, a time of creation of the computing object, an entropy associated with the computing object, packer information associated with the computing object, one or more parameters associated with an operating system of the computing system, or any combination thereof.

In some examples, the indication of whether malware is present on the computing object is encrypted based on using the one or more encrypted ML model features as the inputs to the ML model.

In some examples, the one or more ML model features are encrypted based on a public key associated with the computing system. In some examples, the encrypted indication is decrypted based on a private key associated with the computing system.

FIG. 6 illustrates a block diagram 600 of a system 605 that supports malware detection on encrypted data in accordance with aspects of the present disclosure. The system 605 may be an example of or include the components of a system 405 as described herein. The system 605 may include components for data management, including components such as a storage manager 620, an input information 610, an output information 615, a network interface 625, a memory 630, a processor 635, and a storage 640. These components may be in electronic communication or otherwise coupled with each other (e.g., operatively, communicatively, functionally, electronically, electrically: via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting malware detection on encrypted data). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

The storage manager 620 may support data management in accordance with examples as disclosed herein. For example, the storage manager 620 may be configured as or otherwise support a means for transmitting, by a DMS to a computing system backed up by the DMS, first signaling that instructs the computing system to generate and encrypt one or more ML model features associated with a computing object of the computing system. The storage manager 620 may be configured as or otherwise support a means for receiving, at the DMS from the computing system, second signaling including the one or more encrypted ML model features. The storage manager 620 may be configured as or otherwise support a means for generating, using an ML model and the one or more encrypted ML model features as inputs to the ML model, an encrypted indication of whether malware is present on the computing object. The storage manager 620 may be configured as or otherwise support a means for transmitting, from the DMS to the computing system, the encrypted indication.

By including or configuring the storage manager 620 in accordance with examples as described herein, the system 605 may support techniques for malware detection on encrypted data, which may provide one or more benefits such as, for example, increased data privacy, increased data security, improved malware detection services, and improved user experience associated with maintaining data privacy and security while receiving malware detection services, among other benefits.

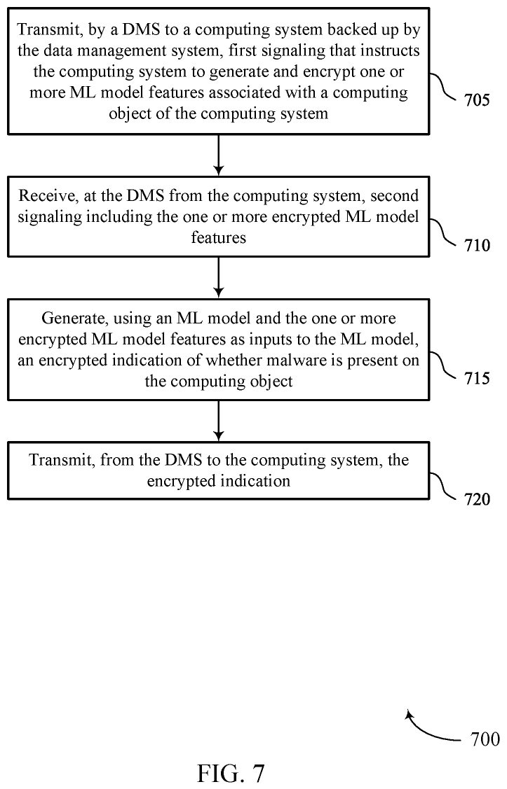

FIG. 7 illustrates a flowchart showing a method 700 that supports malware detection on encrypted data in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include transmitting, by a DMS to a computing system backed up by the DMS, first signaling that instructs the computing system to generate and encrypt one or more ML model features associated with a computing object of the computing system. The operations of 705 may be performed in accordance with examples as disclosed herein. In some examples, aspects of the operations of 705 may be performed by a feature retrieval component 525 as described with reference to FIG. 5.

At 710, the method may include receiving, at the DMS from the computing system, second signaling including the one or more encrypted ML model features. The operations of 710 may be performed in accordance with examples as disclosed herein. In some examples, aspects of the operations of 710 may be performed by a feature reception component 530 as described with reference to FIG. 5.

At 715, the method may include generating, using an ML model and the one or more encrypted ML model features as inputs to the ML model, an encrypted indication of whether malware is present on the computing object. The operations of 715 may be performed in accordance with examples as disclosed herein. In some examples, aspects of the operations of 715 may be performed by a malware detection component 535 as described with reference to FIG. 5.

At 720, the method may include transmitting, from the DMS to the computing system, the encrypted indication. The operations of 720 may be performed in accordance with examples as disclosed herein. In some examples, aspects of the operations of 720 may be performed by a malware indication component 540 as described with reference to FIG. 5.

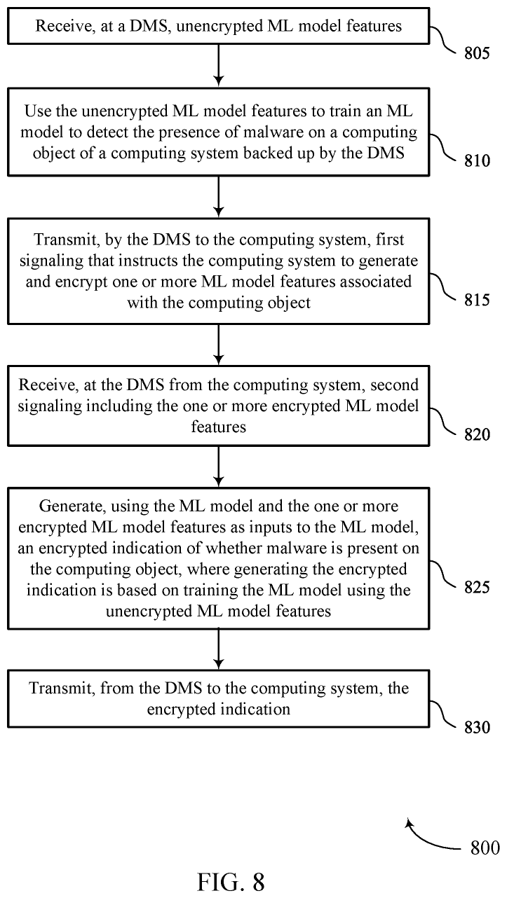

FIG. 8 illustrates a flowchart showing a method 800 that supports malware detection on encrypted data in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 805, the method may include receiving, at a DMS, unencrypted ML model features. The operations of 805 may be performed in accordance with examples as disclosed herein. In some examples, aspects of the operations of 805 may be performed by a feature reception component 530 as described with reference to FIG. 5.

At 810, the method may include using the unencrypted ML model features to train an ML model to detect the presence of malware on a computing object of a computing system backed up by the DMS. The operations of 810 may be performed in accordance with examples as disclosed herein. In some examples, aspects of the operations of 810 may be performed by a training component 545 as described with reference to FIG. 5.

At 815, the method may include transmitting, by the DMS to the computing system, first signaling that instructs the computing system to generate and encrypt one or more ML model features associated with the computing object. The operations of 815 may be performed in accordance with examples as disclosed herein. In some examples, aspects of the operations of 815 may be performed by a feature retrieval component 525 as described with reference to FIG. 5.

At 820, the method may include receiving, at the DMS from the computing system, second signaling including the one or more encrypted ML model features. The operations of 820 may be performed in accordance with examples as disclosed herein. In some examples, aspects of the operations of 820 may be performed by a feature reception component 530 as described with reference to FIG. 5.

At 825, the method may include generating, using the ML model and the one or more encrypted ML model features as inputs to the ML model, an encrypted indication of whether malware is present on the computing object, where generating the encrypted indication is based on training the ML model using the unencrypted ML model features. The operations of 825 may be performed in accordance with examples as disclosed herein. In some examples, aspects of the operations of 825 may be performed by a malware detection component 535 as described with reference to FIG. 5.

At 830, the method may include transmitting, from the DMS to the computing system, the encrypted indication. The operations of 830 may be performed in accordance with examples as disclosed herein. In some examples, aspects of the operations of 830 may be performed by a malware indication component 540 as described with reference to FIG. 5.

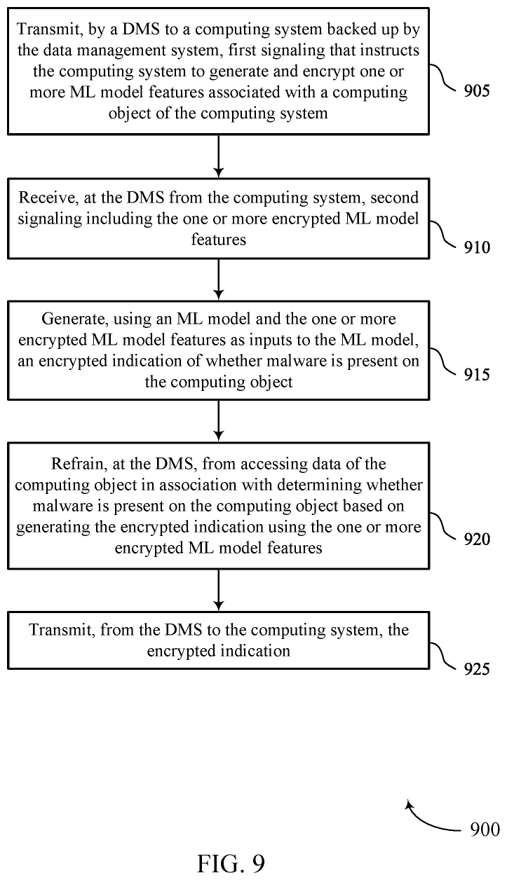

FIG. 9 illustrates a flowchart showing a method 900 that supports malware detection on encrypted data in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 905, the method may include transmitting, by a DMS to a computing system backed up by the DMS, first signaling that instructs the computing system to generate and encrypt one or more ML model features associated with a computing object of the computing system. The operations of 905 may be performed in accordance with examples as disclosed herein. In some examples, aspects of the operations of 905 may be performed by a feature retrieval component 525 as described with reference to FIG. 5.

At 910, the method may include receiving, at the DMS from the computing system, second signaling including the one or more encrypted ML model features. The operations of 910 may be performed in accordance with examples as disclosed herein. In some examples, aspects of the operations of 910 may be performed by a feature reception component 530) as described with reference to FIG. 5.

At 915, the method may include generating, using an ML model and the one or more encrypted ML model features as inputs to the ML model, an encrypted indication of whether malware is present on the computing object. The operations of 915 may be performed in accordance with examples as disclosed herein. In some examples, aspects of the operations of 915 may be performed by a malware detection component 535 as described with reference to FIG. 5.

At 920, the method may include refraining, at the DMS, from accessing data of the computing object in association with determining whether malware is present on the computing object based on generating the encrypted indication using the one or more encrypted ML model features. The operations of 920 may be performed in accordance with examples as disclosed herein. In some examples, aspects of the operations of 920 may be performed by a data access component 550 as described with reference to FIG. 5.

At 925, the method may include transmitting, from the DMS to the computing system, the encrypted indication. The operations of 925 may be performed in accordance with examples as disclosed herein. In some examples, aspects of the operations of 925 may be performed by a malware indication component 540 as described with reference to FIG. 5.

A method for data management is described. The method may include transmitting, by a DMS to a computing system backed up by the DMS, first signaling that instructs the computing system to generate and encrypt one or more ML model features associated with a computing object of the computing system, receiving, at the DMS from the computing system, second signaling including the one or more encrypted ML model features, generating, using an ML model and the one or more encrypted ML model features as inputs to the ML model, an encrypted indication of whether malware is present on the computing object, and transmitting, from the DMS to the computing system, the encrypted indication.

An apparatus for data management is described. The apparatus may include at least one processor, memory coupled with the at least one processor, and instructions stored in the memory. The instructions may be executable by the at least one processor to cause the apparatus to transmit, by a DMS to a computing system backed up by the DMS, first signaling that instructs the computing system to generate and encrypt one or more ML model features associated with a computing object of the computing system, receive, at the DMS from the computing system, second signaling including the one or more encrypted ML model features, generate, using an ML model and the one or more encrypted ML model features as inputs to the ML model, an encrypted indication of whether malware is present on the computing object, and transmit, from the DMS to the computing system, the encrypted indication.

Another apparatus for data management is described. The apparatus may include means for transmitting, by a DMS to a computing system backed up by the DMS, first signaling that instructs the computing system to generate and encrypt one or more ML model features associated with a computing object of the computing system, means for receiving, at the DMS from the computing system, second signaling including the one or more encrypted ML model features, means for generating, using an ML model and the one or more encrypted ML model features as inputs to the ML model, an encrypted indication of whether malware is present on the computing object, and means for transmitting, from the DMS to the computing system, the encrypted indication.

A non-transitory computer-readable medium storing code for data management is described. The code may include instructions executable by a processor to transmit, by a DMS to a computing system backed up by the DMS, first signaling that instructs the computing system to generate and encrypt one or more ML model features associated with a computing object of the computing system, receive, at the DMS from the computing system, second signaling including the one or more encrypted ML model features, generate, using an ML model and the one or more encrypted ML model features as inputs to the ML model, an encrypted indication of whether malware is present on the computing object, and transmit, from the DMS to the computing system, the encrypted indication.

Some examples of the method, apparatuses, and non-transitory computer-readable medium described herein may further include operations, features, means, or instructions for receiving, at the DMS, unencrypted ML model features and using the unencrypted ML model features to train the ML model to detect the presence of malware on the computing object, where generating the encrypted indication may be based on training the ML model using the unencrypted ML model features.

In some examples of the method, apparatuses, and non-transitory computer-readable medium described herein, the one or more ML model features may be encrypted according to a homomorphic encryption scheme and the ML model trained using unencrypted ML model features may be used to detect whether malware may be present on the computing object using the one or more encrypted ML model features as inputs based on the one or more ML model features being encrypted according to the homomorphic encryption scheme.

Some examples of the method, apparatuses, and non-transitory computer-readable medium described herein may further include operations, features, means, or instructions for refraining, at the DMS, from accessing data of the computing object in association with determining whether malware may be present on the computing object based on generating the encrypted indication using the one or more encrypted ML model features.

In some examples of the method, apparatuses, and non-transitory computer-readable medium described herein, presence or absence of malware on the computing object may be unknown to the DMS based on using the one or more encrypted ML model features to generate the encrypted indication.

In some examples of the method, apparatuses, and non-transitory computer-readable medium described herein, the one or more ML model features include an identifier associated with an API called by the computing object, a file size of the computing object, one or more changes to the file size of the computing object, a file header of the computing object, a time of creation of the computing object, an entropy associated with the computing object, packer information associated with the computing object, one or more parameters associated with an operating system of the computing system, or any combination thereof.

In some examples of the method, apparatuses, and non-transitory computer-readable medium described herein, the indication of whether malware may be present on the computing object may be encrypted based on using the one or more encrypted ML model features as the inputs to the ML model.

In some examples of the method, apparatuses, and non-transitory computer-readable medium described herein, the one or more ML model features may be encrypted based on a public key associated with the computing system and the encrypted indication may be decrypted based on a private key associated with the computing system.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
transmitting, by a data management system to a computing system backed up by the data management system, first signaling that instructs the computing system to generate and encrypt one or more machine learning model features associated with a computing object of the computing system;
receiving, at the data management system from the computing system, second signaling comprising the one or more encrypted machine learning model features;
generating, using a machine learning model and the one or more encrypted machine learning model features as inputs to the machine learning model, an encrypted indication of whether malware is present on the computing object; and
transmitting, from the data management system to the computing system, the encrypted indication.

2. The method of claim 1, further comprising:
receiving, at the data management system, unencrypted machine learning model features; and
using the unencrypted machine learning model features to train the machine learning model to detect the presence of malware on the computing object, wherein generating the encrypted indication is based at least in part on training the machine learning model using the unencrypted machine learning model features.

3. The method of claim 2, wherein:
the one or more machine learning model features are encrypted according to a homomorphic encryption scheme, and
the machine learning model trained using unencrypted machine learning model features is used to detect whether malware is present on the computing object using the one or more encrypted machine learning model features as inputs based at least in part on the one or more machine learning model features being encrypted according to the homomorphic encryption scheme.

4. The method of claim 1, further comprising:
refraining, at the data management system, from accessing data of the computing object in association with determining whether malware is present on the computing object based at least in part on generating the encrypted indication using the one or more encrypted machine learning model features.

5. The method of claim 1, wherein presence or absence of malware on the computing object is unknown to the data management system based at least in part on using the one or more encrypted machine learning model features to generate the encrypted indication.

6. The method of claim 1, wherein the one or more machine learning model features comprise an identifier associated with an application programming interface called by the computing object, a file size of the computing object, one or more changes to the file size of the computing object, a file header of the computing object, a time of creation of the computing object, an entropy associated with the computing object, packer information associated with the computing object, one or more parameters associated with an operating system of the computing system, or any combination thereof.

7. The method of claim 1, wherein the indication of whether malware is present on the computing object is encrypted based at least in part on using the one or more encrypted machine learning model features as the inputs to the machine learning model.

8. The method of claim 1, wherein:
the one or more machine learning model features are encrypted based at least in part on a public key associated with the computing system, and
the encrypted indication is decrypted based at least in part on a private key associated with the computing system.

9. An apparatus for data management, comprising:
at least one processor;
memory coupled with the at least one processor; and
instructions stored in the memory and executable by the at least one processor to cause the apparatus to:
transmit, by a data management system to a computing system backed up by the data management system, first signaling that instructs the computing system to generate and encrypt one or more machine learning model features associated with a computing object of the computing system;
receive, at the data management system from the computing system, second signaling comprising the one or more encrypted machine learning model features;
generate, using a machine learning model and the one or more encrypted machine learning model features as inputs to the machine learning model, an encrypted indication of whether malware is present on the computing object; and
transmit, from the data management system to the computing system, the encrypted indication.

10. The apparatus of claim 9, wherein the instructions are further executable by the at least one processor to cause the apparatus to:
receive, at the data management system, unencrypted machine learning model features; and
used the unencrypted machine learning model features to train the machine learning model to detect the presence of malware on the computing object, wherein generating the encrypted indication is based at least in part on training the machine learning model using the unencrypted machine learning model features.

11. The apparatus of claim 10, wherein:
the one or more machine learning model features are encrypted according to a homomorphic encryption scheme, and
the machine learning model trained using unencrypted machine learning model features is used to detect whether malware is present on the computing object using the one or more encrypted machine learning model features as inputs based at least in part on the one or more machine learning model features being encrypted according to the homomorphic encryption scheme.

12. The apparatus of claim 9, wherein presence or absence of malware on the computing object is unknown to the data management system based at least in part on using the one or more encrypted machine learning model features to generate the encrypted indication.

13. The apparatus of claim 9, wherein the one or more machine learning model features comprise an identifier associated with an application programming interface called by the computing object, a file size of the computing object, one or more changes to the file size of the computing object, a file header of the computing object, a time of creation of the computing object, an entropy associated with the computing object, packer information associated with the computing object, one or more parameters associated with an operating system of the computing system, or any combination thereof.

14. The apparatus of claim 9, wherein the indication of whether malware is present on the computing object is encrypted based at least in part on using the one or more encrypted machine learning model features as the inputs to the machine learning model.

15. The apparatus of claim 9, wherein:
the one or more machine learning model features are encrypted based at least in part on a public key associated with the computing system, and
the encrypted indication is decrypted based at least in part on a private key associated with the computing system.

16. A non-transitory computer-readable medium storing code for data management, the code comprising instructions executable by at least one processor to:
transmit, by a data management system to a computing system backed up by the data management system, first signaling that instructs the computing system to generate and encrypt one or more machine learning model features associated with a computing object of the computing system;
receive, at the data management system from the computing system, second signaling comprising the one or more encrypted machine learning model features;
generate, using a machine learning model and the one or more encrypted machine learning model features as inputs to the machine learning model, an encrypted indication of whether malware is present on the computing object; and
transmit, from the data management system to the computing system, the encrypted indication.

17. The non-transitory computer-readable medium of claim 16, wherein the instructions are further executable by the at least one processor to:
receive, at the data management system, unencrypted machine learning model features; and
used the unencrypted machine learning model features to train the machine learning model to detect the presence of malware on the computing object, wherein generating the encrypted indication is based at least in part on training the machine learning model using the unencrypted machine learning model features.

18. The non-transitory computer-readable medium of claim 17, wherein:
the one or more machine learning model features are encrypted according to a homomorphic encryption scheme, and
the machine learning model trained using unencrypted machine learning model features is used to detect whether malware is present on the computing object using the one or more encrypted machine learning model features as inputs based at least in part on the one or more machine learning model features being encrypted according to the homomorphic encryption scheme.

19. The non-transitory computer-readable medium of claim 16, wherein presence or absence of malware on the computing object is unknown to the data management system based at least in part on using the one or more encrypted machine learning model features to generate the encrypted indication.

20. The non-transitory computer-readable medium of claim 16, wherein the one or more machine learning model features comprise an identifier associated with an application programming interface called by the computing object, a file size of the computing object, one or more changes to the file size of the computing object, a file header of the computing object, a time of creation of the computing object, an entropy associated with the computing object, packer information associated with the computing object, one or more parameters associated with an operating system of the computing system, or any combination thereof.
